(19) United States
(12) Patent Application Publication
(10) Pub. No.: US 2007/0234486 A1
(43) Pub. Date: Oct. 11, 2007

(54) Method and Device for Controlling a Dyeing Machine

(76) Inventor: Georges Cornuejols, Paris (FR)

Correspondence Address: YOUNG & THOMPSON, 745 SOUTH 23RD STREET, 2ND FLOOR, ARLINGTON, VA, 22202, US

(21) Appl. No.: 10/576,599

(22) PCT Filed: Oct. 21, 2004
(86) PCT No.: PCT/FR04/02706

§ 371 Date: Feb. 14, 2007

(30) Foreign Application Priority Data
Oct. 21, 2003 (FR) 0312319
Oct. 21, 2003 (FR) 0312320
Oct. 21, 2003 (FR) 0312321

(51) Int. Cl. D06B 23/28; G01N 21/85

(52) U.S. Cl. 8/400; 73/53.01

(57) ABSTRACT

The monitoring device for dye baths in which a dye component is introduced during a period of time D includes:
a transparency sensor (140) for the liquid contained in the bath adapted to supply a signal representing the transparency of the bath for at least one spectral range and
control elements (148) adapted to determine a reference point (315) for transparency evolution of the bath corresponding to the transparency that the bath would have had if there had been no absorption of the colorant during the period of time D. Preferentially, the reference point is determined by interpolating transparency evolution to the start of the introduction, interpolation carried out over the period of time D of the introduction of colorant into the dye bath.

This invention concerns a method and a device for measuring transparency and controlling baths. It applies, in particular, to the control of dye bath exhaustion for the textile industry.

There are already many systems measuring dye bath exhaustion. These systems comprise specific means of pumping that impose a high manufacturing cost.

In addition, when colorant is introduced into a bath, the colorant begins to be fixed on the fabric to be dyed before all the colorant has been introduced, which hampers the correct calibration of systems measuring bath exhaustion.

Finally, there is no known system to control a dyeing machine's rinsing.

This invention intends to remedy these inconveniences.

According to a first aspect, the present invention envisages a monitoring device for dye baths in which a dye component is introduced during a period of time D characterized in that it comprises:
a transparency sensor for the liquid contained in said bath adapted to supply a signal representing the transparency of said bath for at least one spectral range and
control means adapted to determine a reference point for transparency evolution of the bath corresponding to the transparency that the bath would have had if there had been no absorption of the colorant during the period of time D.

Thanks to these provisions, the dye fixing that took place during the period of time D does not hinder the calibration of the device and the monitoring of transparency according to the reference point.

According to particular features, the control means are adapted to determine said reference point by interpolating transparency evolution to the start of the introduction, interpolation carried out over the period of time D of the introduction of colorant into the dye bath.

Thanks to these provisions, the determination of the reference point is easy.

According to particular features, the control means are adapted to determine said reference point according to the product of the derivative of the transparency at the beginning of the period of time of the introduction of the colorant into the dye bath, by the period of time D.

Thanks to these provisions, the determination of the reference point is easy.

According to particular features, the control means are adapted to determine the period of time D by the measurement of the length of time of the decrease of the bath's transparency.

Thanks to these provisions, determining the period of time D is easy and autonomous: it is not necessary, for this determination, to utilize a sensor other than the transparency sensor.

According to particular features, the control means are adapted to determine a complementary reference point for transparency evolution for clean water by memorizing a value representing the signal output by the transparency sensor during a passage of clean water or white bath in the sensor.

Thanks to these provisions, transparency evolution can be processed according to two extreme reference points.

According to particular features, the control means are adapted to control the end of dyeing according to the evolution of the bath's transparency and at least one reference point for transparency evolution.

Thanks to these provisions, the duration of the dyeing phase can be optimized and savings in power, equipment use, and water can be realized.

According to particular features, the control means are adapted to determine the end of dyeing when the derivative for the transparency value is below a predefined value.

Thanks to these provisions, the end of the dyeing period is determined in an easy manner.

According to a second aspect, the present invention envisages a dye bath monitoring method in which a dye component is introduced during a period of time D characterized in that it comprises:
a step of capturing the transparency of the liquid contained in said bath during which a signal representing the transparency of said bath is provided for at least one color and
a step of determining a reference point for evolution of the bath's transparency corresponding to the initial transparency if the whole of the dye component had been introduced and mixed to the dye bath in a fraction of the period of time D and at the start of the period of time D.

As the particular characteristics, advantages, aims of this method are similar to those of the dye bath monitoring device as described in brief above, they are not repeated here.

According to a third aspect, this invention envisages a dye bath monitoring device characterized in that it comprises:
a transparency sensor for the liquid contained in said bath adapted to supply a signal representing the transparency of said bath for at least one spectral range and
control means adapted to determine the end of a rinse period for said bath according to the evolution of the transparency of the bath.

Thanks to these provisions, the duration of the rinse phase can be optimized and savings in power, equipment use and water can be realized.

According to particular features, the control means are adapted to control the end of the rinse period for a dyeing machine comprising said dye bath.

Thanks to these provisions, rinsing is stopped automatically.

According to particular features, the control means are adapted to determine a complementary reference point of transparency evolution for clean water or white bath by memorizing a value representing the signal output by the sensor during a passage of clean water or white bath in the sensor.

Thanks to these provisions, the transparency evolution can be processed according to an extreme reference point.

According to particular features, in a dyeing phase, a dye component is introduced during a period of time D and the control means are adapted to determine a reference point for evolution of the bath's transparency corresponding to the initial transparency if the whole of the dye component had been introduced and mixed to the dye bath in a fraction of the period of time D and at the start of the period of time D.

Thanks to these provisions, the dye fixing that took place during the period of time D does not hinder the calibration of the device and the monitoring of transparency according to the reference point.

According to particular features, the control means are adapted to determine the end of the rinse period for said bath according to the transparency evolution of the bath and at least one reference point for transparency evolution.

Thanks to these provisions, the duration of the rinse phase can be optimized and savings in power, equipment use and water can be realized.

According to particular features, the control means are adapted to determine the end of the rinse period when the derivative for the transparency value is below a predefined value.

Thanks to these provisions, the end of the rinse period is determined in an easy manner.

According to a fourth aspect, the present invention envisages a dye bath monitoring method characterized in that it comprises:
a step of capturing the transparency of the liquid contained in said bath during which a signal representing the transparency of said bath is provided for at least one color and
a step of determining the end of a rinse period for said bath according to the transparency evolution of the bath.

As the particular characteristics, advantages, aims of this method are similar to those of the dye bath monitoring device as described in brief above, they are not repeated here.

According to a fifth aspect, the present invention envisages a dye bath monitoring device intended to be combined with a dyeing machine comprising at least one liquid circulation circuit comprising the dye bath, characterized in that is comprises:
a transparency sensor for the liquid contained in said bath adapted to supply a signal representing the transparency of said bath for at least one spectral range and
a positioning means for positioning the transparency sensor in a said liquid circulation circuit comprising the dye bath.

Thanks to these provisions, it is not necessary to have a special dye water circuit for the transparency sensor, the water circuits normally present on dyeing machines being used for positioning the transparency sensor.

According to particular features, the positioning means comprises a sensor support adaptable to said circuit.

Thanks to these provisions, the positioning means can be welded or screwed, for example, in said circuit.

According to particular features, the positioning means comprises a displacement means for said sensor adapted to move the sensor into or outside the original liquid contained in the dye bath.

Thanks to these provisions, the sensor can be placed into the flow of liquid or away from said flow, according to the phases of operation of the dyeing machine.

According to particular features, said displacement means comprises a piston placed transversely with respect to said liquid circulation circuit.

Thanks to the provisions, the displacement means is easy and not expensive to manufacture.

According to particular features, the control means are adapted to control the end of dyeing according to the evolution of the bath's transparency and at least one reference point for transparency evolution.

Thanks to these provisions, the duration of the dyeing phase can be optimized and savings in power, equipment use, and water can be realized.

According to particular features, the control means are adapted to determine the end of dyeing when the derivative for the transparency value is below a predefined value.

Thanks to these provisions, the end of the dyeing period is determined in an easy manner.

According to particular features, the control means comprise closed-loop control means that control the sensor's sensitivity according to the opacity of the liquid contained in the dye bath.

According to particular features, the control means comprise closed-loop control means that control the optic path taken by a light ray generated by the sensor in the liquid contained in the dye bath according to the opacity of the liquid contained in the dye bath.

According to particular features, the device as described in brief above comprises, in addition, an adjusting means for adjusting the thickness of the sample of dye bath water whose transparency is captured by the transparency sensor and the control means are adapted to control the adjusting means for adjusting the thickness in such a manner that the sample thickness is increased according to the transparency of the bath.

Thanks to these provisions, by adjusting the sample thickness, the transparency measurement is carried out making advantageous use of the sensor dynamics. In effect, any capture means gives a signal that comprises “noise”, i.e. a random interference or disturbance and, thanks to these provisions, the signal output from the capture means has an intensity high enough for the signal/noise ratio to be favorable.

According to particular features, the control means comprise closed-loop control means for controlling the capture period of time for the sensor according to the opacity of the liquid contained in the dye bath.

According to particular features, the control means comprise closed-loop control means for controlling amplification means that amplifies the signal/noise ratio of the signal output from the sensor, according to the opacity of the liquid contained in the dye bath.

According to particular features, the adjusting means that adjusts thickness is adapted to displace, with relation to each other, a light source and at least one optical fiber.

Thanks to these provisions, the sensor, positioned at the other end of the optical fiber, is protected from the flow of liquid contained in the dye bath, on the one hand, and, on the other hand, the dimensions of the device units placed in the path of this liquid are reduced.

According to particular features, the control means are adapted to utilize the Bert-Lambert law.

According to particular features, the control means are adapted to control the acidity and/or the salinity of the dye bath according to evolution of the transparency of the liquid contained in the dye bath.

According to particular features, the control means are adapted to control the temperature of the bath according to evolution of the transparency of the liquid contained in the dye bath.

According to particular features, the control means are adapted to control the quantity of clean water introduced into the dye bath according to evolution of the transparency of the liquid contained in the dye bath.

According to particular features, the control means are adapted to control the quantity of colorant introduced into the dye bath according to evolution of the transparency of the liquid contained in the dye bath.

According to particular features, the control means are adapted to control the quantity of chemical components introduced into the dye bath according to evolution of the transparency of the liquid contained in the dye bath.

For example, the chemical components are alkaline liquids or salts.

According to a sixth aspect, the present invention envisages a dye bath monitoring method intended to be utilized in a dye bath monitoring device combined with a dyeing machine comprising at least one liquid circulation circuit comprising the dye bath, characterized in that it comprises:
a step of positioning a transparency sensor in a said liquid circulation circuit comprising the dye bath and
a step of capturing the transparency of the liquid contained in said bath, during which a signal representing the transparency of said bath is provided for at least one color.

As the particular characteristics, advantages, aims of this method are similar to those of the dye bath monitoring device as described in brief above, they are not repeated here.

The inventor has noted that the presence of bubbles or foam in the dye bath often interferes with the measurement of the transparency of the dye bath.

The present invention intends, according to some of its aspects, to remedy these inconveniences.

To this end, the present invention envisages, according to a seventh aspect, a dye bath monitoring method intended to be combined with a dyeing machine comprising at least one liquid circulation circuit comprising the dye bath, characterized in that it comprises:
a taking means for taking a sample of the dye bath,
a separating means for separating said sample from the dye bath and leaving said sample to rest for a period,
a sensor of the transparency of the sample separated from the dye bath adapted to supply a signal representing the transparency of said sample for at least one spectral range and
a rinsing means for rinsing the sensor.

Thanks to these provisions, once the sample has been separated from the dye bath and left to rest for a period, the bubbles possibly present in the sample are progressively released from the liquid and the sensor can measure the actual transparency of the liquid.

According to particular features, the taking means for taking samples comprises a piston set in movement.

According to particular features, said piston can take at least one position in which the sample is in the bath and one position in which the sample is separated from said bath.

According to particular features, the taking means for taking samples is adapted to take the sample in the liquid circulation circuit comprising the dye bath.

According to particular features, the sensor is positioned in said liquid circulation circuit.

According to particular features, the rinsing means for rinsing the sensor comprises a circuit of clean water under pressure.

According to particular features, the taking means for taking samples and the rinsing means are adapted in order that, during the taking of the sample, the sensor is rinsed.

According to particular features, the device as described in brief above comprises a control means for controlling a sample thickness between said sensor and a light source.

According to particular features, the control means for controlling the sample thickness comprises a piston.

According to particular features, the control means for controlling the sample thickness comprises a spring.

According to particular features, the device as described in brief above comprises two light sources adapted to output different amounts of light opposite to said sensor and a switching means for switching between said light sources.

According to particular features, the device as described in brief above comprises an anti-foam filter positioned between the position of the sample at the moment it is taken and the position of the sample separated from the dye bath.

According to particular features, the device as described in brief above comprises a piston which is adapted to take at least three positions in which, respectively:
a water passage is open opposite to the circuit of clean water under pressure,
the water passage is opposite to the liquid circulation circuit comprising the dye bath and
the water passage is blocked off and opposite to the sensor.

The devices measuring dye bath exhaustion present great optical complexity, utilizing a number of chromatic filters and a number of luminosity sensors associated to these filters. The manufacturing and maintenance costs and the risks of breakdowns are therefore very high.

The present invention intends, according to some of these aspects, to remedy these inconveniences.

To this end, the present invention envisages, according to an eighth aspect, a dye bath monitoring device, characterized in that it comprises:
a transparency measurement chamber for liquid coming from the dye bath comprising a light source adapted to successively output light in a plurality of different spectral bands,
a single optoelectronic sensor adapted to receive the light rays coming from the light source after their passage through the measurement chamber and to output a signal representing the quantity of light received by said sensor and
a demodulator synchronized with the light source to successively process the signals coming from the sensor to supply results corresponding to the different spectral bands successively output by the light source.

Thanks to these provisions, a single sensor is enough to process the different spectral bands used for measuring the bath's transparency and to monitor the dye bath's exhaustion or the rinse operation.

According to particular features, said light source comprises a plurality of light sources adapted to output light in a plurality of different spectral bands between the different light sources and a modulator adapted to cause said light sources to light up alternately.

Thanks to these provisions, powerful light sources can be used.

According to particular features, said light source comprises at least one light-emitting diode.

Thanks to these provisions, the light source does not generate a lot of heat and presents a long service life.

According to particular features, the light source comprises at least one electro-optic transducer whose spectral band depends on a characteristic of the electrical signal applied to it and a modulator adapted to modify said characteristic by alternation.

According to particular features, the light source comprises a light-emitting diode whose output spectral band depends on the voltage applied to it.

Thanks to each of these provisions, a single electro-optical transducer, for example the light-emitting diode, can successively output light rays according to different spectral bands by the simple modification of the signal applied to it.

According to particular features, for each light source, after each lighting up corresponding to the same spectral band output, the signals output by the sensor corresponding to the same instant of time, with respect to the lighting up time, are processed.

Thanks to these provisions, the variations in wavelength or candlepower output do not interfere with the comparison of successive results for processing performed with the same light source and for the same spectral band.

As the particular features, advantages and aims of the different aspects of the method that is the subject of the present invention, described in brief above, are similar to those of the devices as described in brief above, they are not repeated here.

The particular features of each of the aspects of the present invention constitute particular features of all the aspects of the present invention. However, in the aim of conciseness, these particular features are not re-copied with respect to each of the aspects mentioned above.

The different aspects of the present invention are preferentially combined with each other to produce a method and a device for measuring transparency and controlling baths that benefits from the particular features, aims and advantages of these different aspects.

Other advantages, aims and characteristics of the present invention will become apparent from the description that will follow, made, as an example that is in no way limiting, with reference to the drawings included in an appendix, in which:

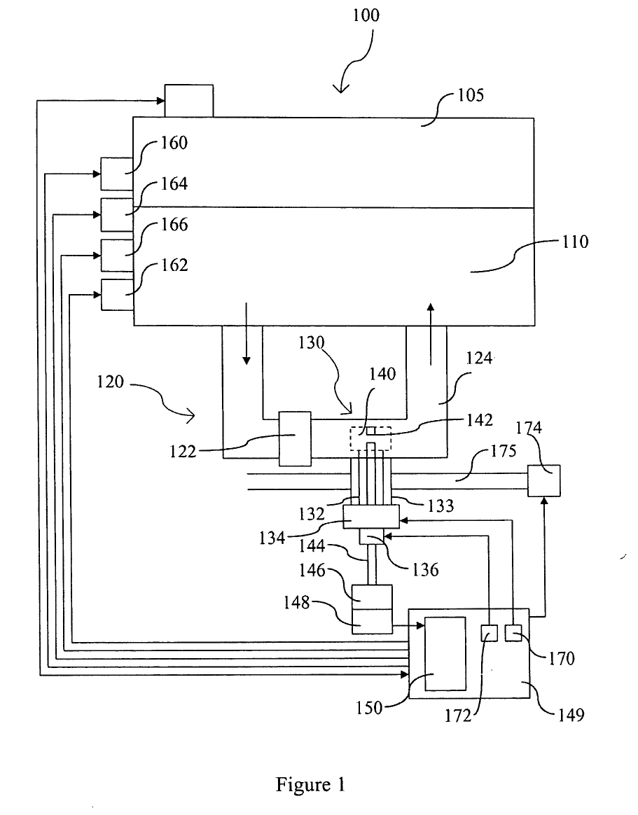

FIG. 1 represents, schematically, a first embodiment of the device that is the subject of this invention,

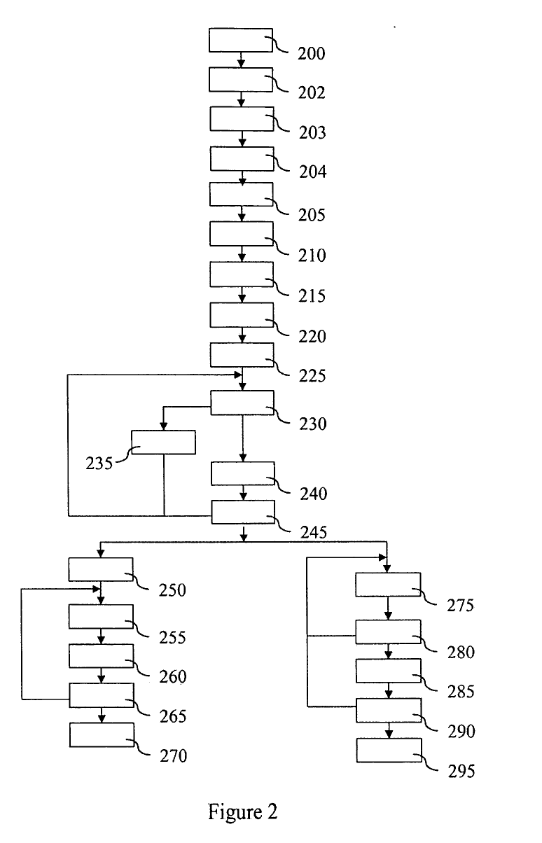

FIG. 2 represents a logical diagram of steps performed by the embodiment of the device shown in FIG. 1,

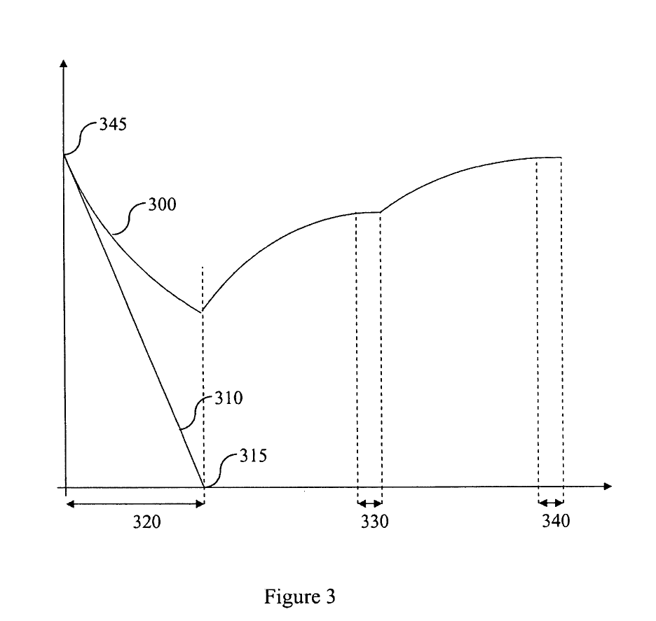

FIG. 3 represents a curve of transparency by time and measurements performed or calculated with the device shown in FIG. 1 utilizing the logical diagram shown in FIG. 2,

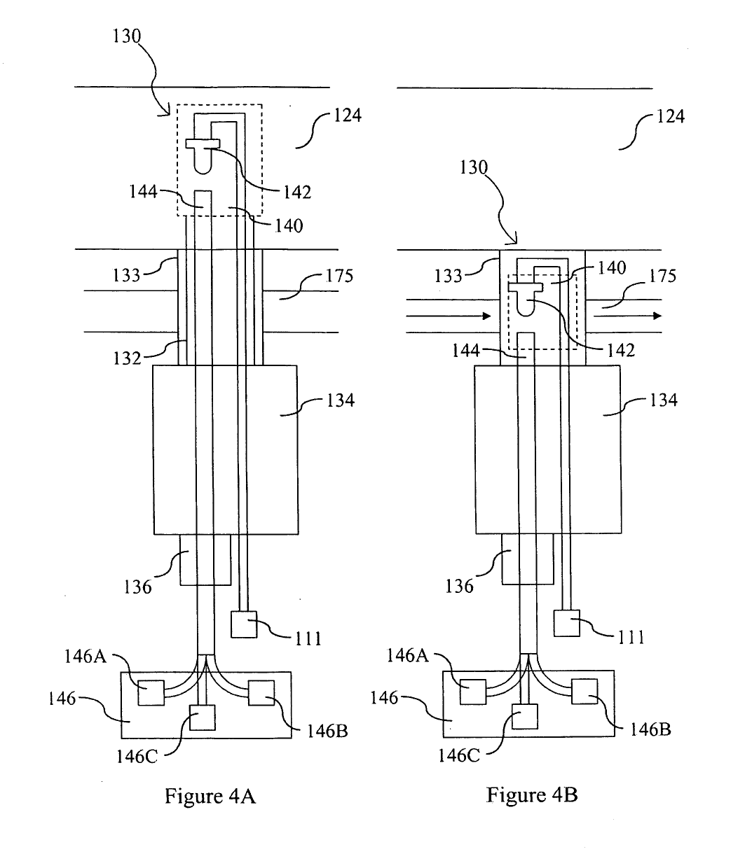

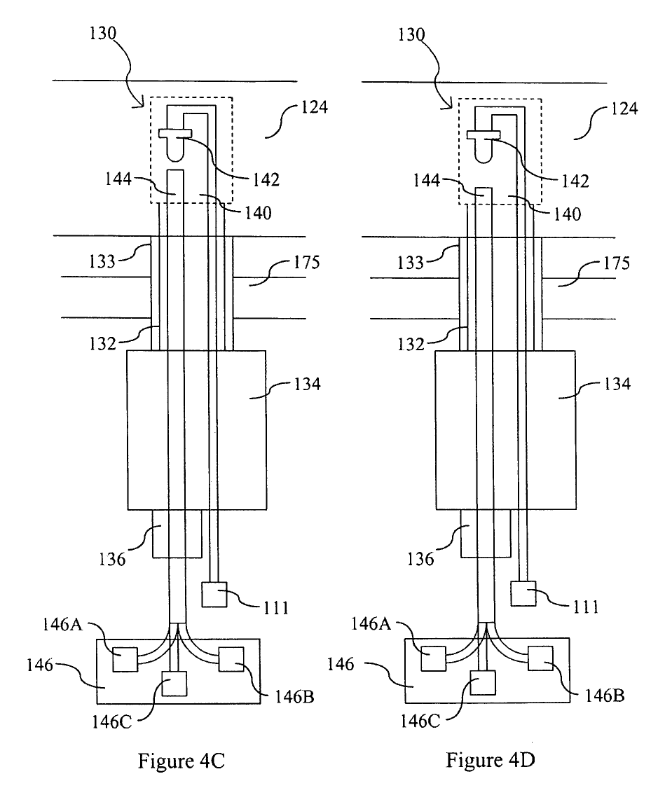

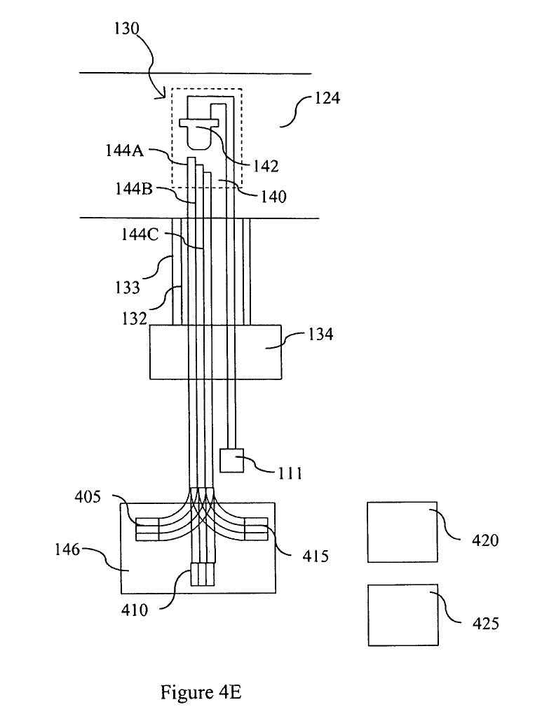

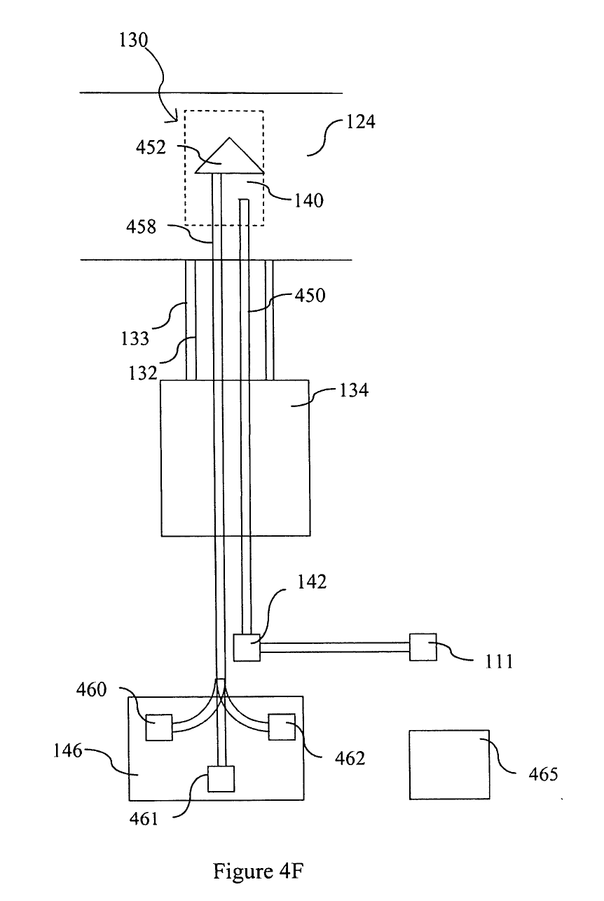

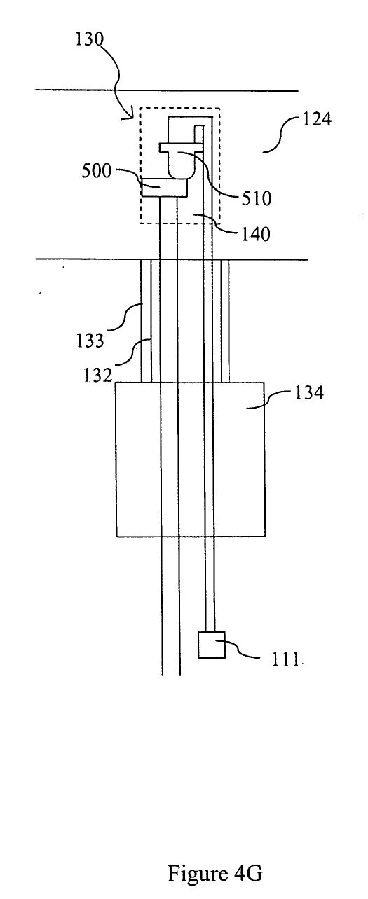

FIGS. 4A to 4G represent, schematically, sensors able to be utilized in the device that is the subject of this invention,

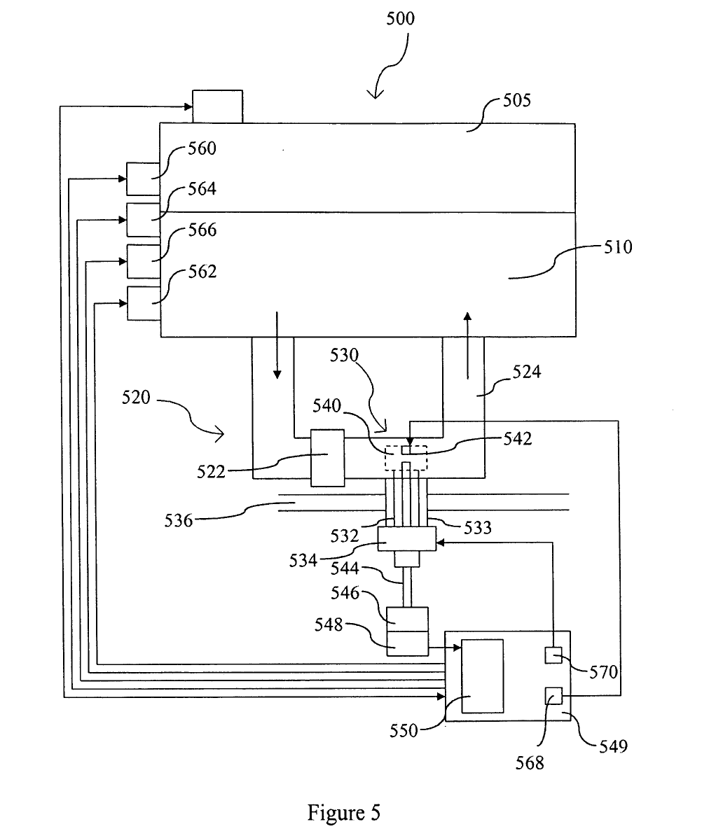

FIG. 5 represents, schematically, a second embodiment of the device that is the subject of this invention,

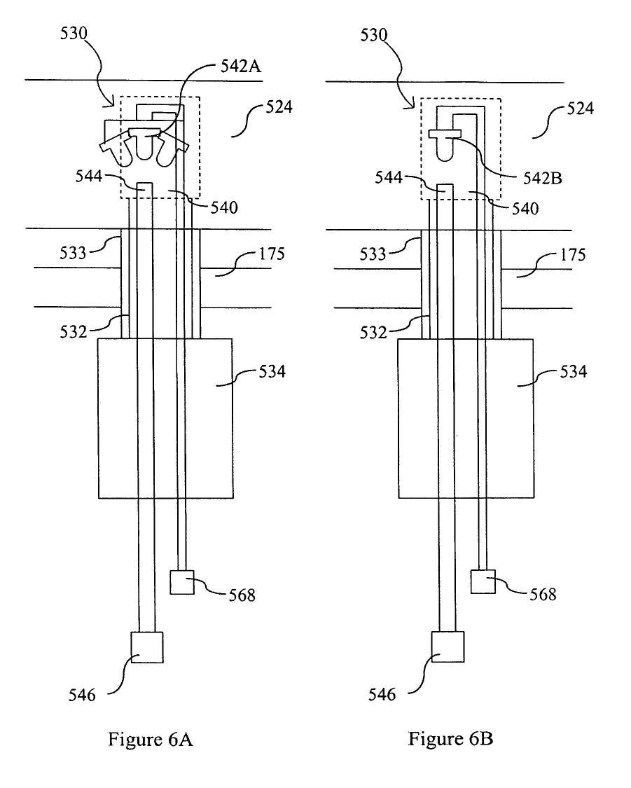

FIGS. 6A and 6B represent, schematically, two embodiments of light sources capable of being incorporated in the embodiment of the device that is the subject of this invention shown in FIG. 5 and

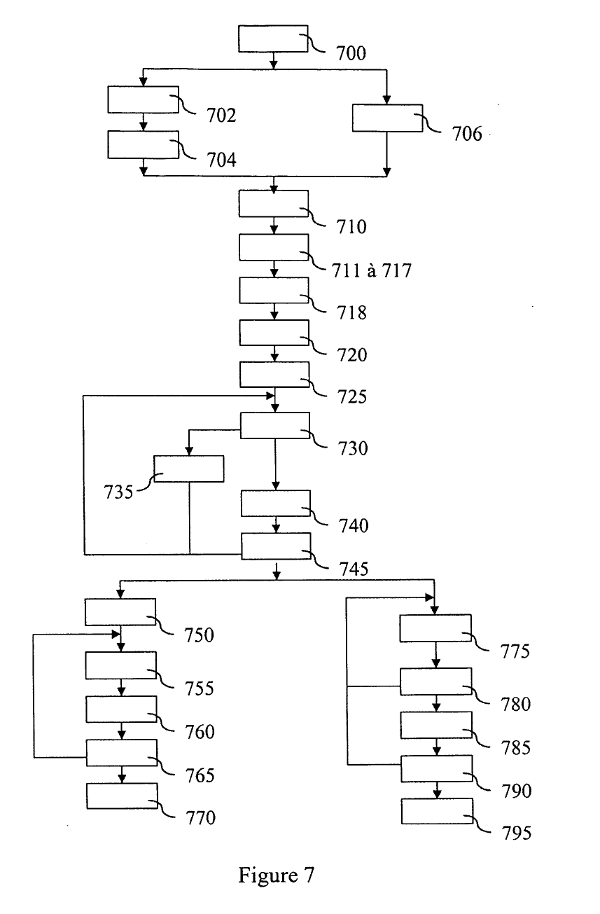

FIG. 7 represents a logical diagram of steps performed by the embodiment shown in FIGS. 5, 6A and 6B.

Throughout the whole description, the terms “sensor” and “capture means” are used indifferently. Equally, the terms “derivative” and “variation” are used indifferently. Lastly, the terms “the colorant” and “the colorants” are used indifferently.

FIG. 1 shows:
a dyeing machine 100 controlled by a programmer 105 and filled with a dye bath 110 during dyeing phases, this dyeing machine circulating the bath around the piece of material or spools of thread to be dyed, the movement of the bath being caused by a circulation circuit of the dye bath 120, comprising a pump 122, a pipe 124 removing bath water in the bath 110 and re-injecting it into the bath 110,
an analysis chamber 130 comprising a piston 132 moved by a motor 134 inside a cylinder 133, the piston 132 displacing a transparency capturing means 140 comprising a light source 142 powered by a power supply 111 (FIGS. 4A to 4G), and a bundle of optical fibers 144 whose output is opposite to a sensor 146 linked to a digitizer 148,
displacing means 136 for displacing the input of the bundle of optical fibers 144 from or towards the light source 142 (see FIGS. 4A and 4D and variants in FIGS. 4E to 4G),
control means 149 comprising:
   . an analyzing means 150 for analyzing signals receiving the digitized signals output from the digitizer 148 and supplying an analysis result,
   . a closed-loop control means 160 for controlling the acidity and/or salinity of the bath,
   . a closed-loop control means 162 for controlling the temperature of the bath,
   . a closed-loop control means 164 for controlling the clean water feed in the bath 110,
   . a closed-loop control means 166 for controlling the injection of colorant into the bath,
   . a control means 170 for controlling the motor 134 of the piston 132 and
   . a control means 172 for controlling the displacement means 136 and
   . a communication means (not shown) for communicating with the programmer 105, for exchanging operational data for the dyeing machine and enabling the programmer 105 to memorize or transmit traceability data for dyeing operations.

The dyeing machine 100 and the composition of the dye bath 110 are of known types in the textile industry. Preferentially, the place where the colorant is introduced is situated close to the inlet for the circulation circuit of the dye bath 120 in order that the colorant is dissolved in the water present in the pipe before reaching the piece of material of the threads to be dyed. If the place where the colorant is introduced is located in the pipe 124, the analysis chamber is situated upstream of this place, depending on the direction of circulation of the liquid from the dye bath in this pipe 124.

The circulation circuit of the dye bath 120 already exists in a large number of dyeing machines. The pump 122 and the pipe 124 are of known types and already exist in a large number of dyeing machines. They are used to provide the relative movement of the piece of material to be dyed with respect to the dye bath. They are constituted of materials that do not risk polluting the dye bath or distorting its analysis. Preferentially, the pump 122 has a constant flow rate, possibly adjustable.

The cylinder 133 constitutes a positioning means for positioning the transparency sensor 140 in the circulation circuit 120 of the liquid contained in the dye bath. This positioning means comprises a sensor support adaptable to said circuit, for example by drilling a hole in the pipe 124 then gluing, riveting and/or screwing an adaptor (not shown) or by replacing an element of the pipe 124.

The positioning means comprises a displacement means 132 for displacing the sensor 140 which displaces the sensor in or outside the initial circuit of liquid contained in the dye bath, initial circuit delineated by the pipe 124.

In the example shown in FIG. 1, said displacement means comprises a piston 132 placed transversely with respect to the liquid circulation circuit.

The analysis chamber 130 is constituted of a part of the pipe 124 and the piston 132, set in movement by the motor 134 under the control of the control means 170. Thanks to this piston mechanism, it is no longer necessary to have a pipe specific to the dyeing machine control device and the complexity and costs of manufacturing, installing and maintaining this device are substantially reduced.

When the piston 132 is in the deployed (or raised) position, the transparency capturing means 140 is placed in the analysis chamber 130, which comprises, opposite to each other, the light source 142 and the bundle of optical fibers 144. The analysis chamber 130 also comprises displacement means 136 for displacing the input of the bundle of optical fibers 144 away from or towards the light source 142. For example, the displacement means 136 comprise a stepping motor controlled by the control means 172. The distance between the input of the bundle of optical fibers 144 and the light source 142 varies, preferentially, at least over the band of values in the range 0.1 mm. to 7 mm.

When the piston 132 is in the sunken (or lowered) position, the transparency capturing means 140 is placed in the cylinder 133, outside of the pipe 124, opposite to a clean water inlet coming from a pipe 175 and going to an outlet of clean water towards the rest of the pipe 175.

The circulation of water in the pipe 175 has two functions. This circulation makes it possible to clean the transparency capturing means 140 and, in particular, its optical elements. In a variant, this circulation also makes it possible to measure a clean water transparency.

This circulation, controlled by a solenoid valve 174 is controlled by the control means 149 (as shown in FIG. 1), by the programmer 105 of the dyeing machine 100 or, in a variant, manually by an operator.

In a variant, the piston serves as a shutter for the pipe 175 and the solenoid valve is not utilized.

The light source 142 is, for example, an incandescent bulb, a halogen light or a light-emitting diode emitting a white light. The digitizer 148, of known type, digitizes the signal output from the sensor 146. This digitizing can be performed on a single channel and represent a wide spectral range, for example visible light. This digitizing can also by performed over a number of channels representing different spectral ranges, for example, red, green and blue light, the sensor 146 then comprising a number of sensors reacting in the different spectral ranges, for example by being equipped with optical filters of known type, each channel being linked to one of these sensors.

The digitizing can be performed by a single digitizer linked, by means of a multiplexer, to each of the sensors dedicated to a particular spectral range (for example, red, green and blue) or by as many digitizers as there are sensors.

The analyzing means for analyzing signals 150, which receives the digitized signals output from the digitizer 148 utilizes the logical diagram shown in FIG. 2:
to calibrate the transparency capturing means, then
to provide an analysis result in the form of a transparency value for each spectral range used,
during the dyeing phase, to provide a comparison of the derivative of each of these transparency values with at least one predefined threshold value, possibly according to the composition of the dye bath and/or its reference points and
during the rinse phase, to provide a comparison of the derivative of each of the transparency values with at least one predefined threshold value, possibly according to the composition of the dye bath and/or its reference points.

It is noted that the predefined threshold values can depend on the spectral range looked at. In a variant, during the dyeing phase the analyzing means for analyzing signals 150 compares the transparency values with predefined threshold values, possibly depending on the composition of the bath and/or its reference points. In the same way, in a variant, during the rinse phase, the analyzing means for analyzing signals 150 compares the derivatives of the transparency values with at least one predefined threshold value, possibly depending on the composition of the dye bath and/or its reference points.

The analyzing means for analyzing signals is, for example, constituted of a computer programmed to implement the steps shown in FIG. 2. It comprises a user interface (not shown) comprising a display screen, a keyboard and, possibly, a pointing device, for example a mouse.

The closed-loop control means for controlling bath acidity and/or salinity 160, the closed-loop control means for controlling bath temperature 162, the closed-loop control means for controlling the clean water feed 164, the closed-loop control means for controlling the injection of colorant into the bath 166 respectively control, depending on the results provided by the analyzing means for analyzing signals, the operation of at least one valve for injecting chemical components into the bath, the operation of a heat source, for example constituted of a heat exchanger or a steam pipe, a clean water feed valve, a valve for injecting colorant into the bath. It is noted that the term “valve” does not prejudge the state, liquid, solid or gaseous, of the colorant or colorants and/or the other chemical components, for example alkalines, that may be injected into the dye bath.

FIG. 2 shows a series of steps performed by the embodiment of the device shown in FIG. 1, in the case where the textile fibers to be dyed are placed in the dyeing machine before the colorants are introduced and in the case where the colorants are likely to cause a “first strike” phenomenon. The people in the field know how to easily adapt the steps described below to other situations of dye machine utilization. They will not therefore be detailed in this description.

It is acknowledged that, initially, the dyeing machine is filled with clean water and possible products intended to help the proper operation of the dyeing operations. This bath, which does not yet contain colorant, is called the “white bath”. It is also acknowledged that the initial white bath is already at the required dyeing temperature. If not, when the clean water is introduced, the dye bath heating is initiated, until it is at the required temperature.

During a step 200 of industrial process selection, a user selects a dyeing process by supplying a value for the weight of material to be dyed, an identification of the colorant or colorants to be used and a quantity of colorant to be injected into the dye bath. During the step 202, the displacement of the transparency sensor with relation to the light source is actuated, depending on the colorant selected and the quantity of colorant to be introduced into the dye bath.

In a variant, to avoid having to receive the data indicated above, a white bath transparency measurement is performed for each (for example three) predefined thickness and, during the transparency measurement for the dye bath comprising the colorants, a transparency measurement is performed for each predefined thickness.

In a variant, depending on the transparency measurement, the thickness of the sample with which the transparency is measured is varied, during dyeing, according to this transparency, a coefficient of correction then being applied to the measurement carried out, depending on the thickness of the sample.

The device that is the subject of the present invention can thus be completely automatic.

During a step 203, the sensor being in the raised position, in the pipe 124, the water in the white bath is circulated in front of the sensor and after a period of cleaning the transparency capturing means 140, the transparency of the clean water circulating in the transparency capturing means 140 is measured, for each spectral range used. Preferentially, several digital values are obtained and it is their average (after possibly excluding values too far from the average value) that is considered as the measurement result and serves as additional reference point (“white bath measurement”) for evolution of the transparency of the dye bath.

During a step 204, the deployment of the piston 132 is actuated in order to position the transparency capturing means 140 in the circulation circuit of the dye bath 120.

In a variant, in addition to step 203 which then serves only to clean the transparency capturing means 140, during a step 205, the sensor is put in the lowered position, in the pipe 175 and the passage of clean water in front of the sensor is actuated. During a step 210, clean water passes through the analysis chamber 130 and the transparency of the clean water circulating in the transparency capturing means 140 is measured. Preferentially, several digital values are obtained and it is their average (after possibly excluding values too far from the average value) that is considered as the measurement result and serves as additional reference point for evolution of the transparency of the dye bath. This variant is preferentially utilized when a chemical component likely to influence the transparency of the dye bath is introduced into the dye bath before the colorants are introduced.

Following one of steps 203 or 205, during a step 215, the analyzing means memorizes the result of the measurement corresponding to the clean water or white bath transparency. This measurement is called the “white bath” measurement.

Then, during a step 220, the movement of the bath with respect to the textile fibers to be dyed (piece or threads) and the introduction, into the dye bath (initially constituted of a white bath), of colorants and, possibly, additional chemical components intended to activate or complete the dyeing of the textile product in the dye bath, is actuated. During the step 220, of a length of time D, the analyzing means memorizes a series of digital values representing the transparency output from the digitizer for each spectral range utilized (for example three spectral ranges of the visible field, as shown in 4A to 4D).

When the initial introduction of colorants and chemical components is finished, during a step 225, the analyzing means determines, for at least one spectral range utilized:
the reference point (315, FIG. 3) of the curve of future values, for each spectral range and
the “first strike” rate for each spectral range.

The reference point 315 for evolution of the transparency of the bath corresponds preferentially to the transparency that the dye bath would have had if there had been no absorption of the colorant during the period of time D.

The reference point of the curve is, in a mode of determination adapted to cases where the colorant is introduced, at a constant flow rate, into the circulation circuit of the dye bath 120, upstream of the transparency capturing means 140, as a first approximation, a transparency value (Y co-ordinate) as a point of the tangent, at the start of the introduction of the colorant, of the transparency curve by time (see FIG. 3), a point that corresponds to the moment when the introduction of colorants into the dye bath ended (X co-ordinate).

In a mode of determining the reference point adapted to cases where the colorant is introduced, at a constant flow rate, into the dye bath at a distance from the circulation circuit of the dye bath 120, a first multiplier coefficient determined experimentally is applied to the gradient of the tangent indicated in the previous paragraph to determine the reference point as indicated above. For example, if the gradient of the tangent is equal to −4% of the value of the initial transparency (“white bath”) per minute of introduction of colorant, this tangent is raised to −5% if, for the textile product to be dyed and for the initial temperature and pH of the dye bath, it is determined that 20% of the colorant was absorbed by this textile product before the dye bath passed in front of the transparency capturing means 140 at the beginning of the phase introducing colorant into the dyeing machine.

In a mode of determining the reference point adapted to cases where the colorant is introduced, at a non-constant flow rate, into the dye bath, a second multiplier coefficient inversely proportional to the snapshot colorant flow rate is applied to the gradient on each point of the tangent indicated above to determine the reference point as indicated above. For example, if the gradient of the tangent is equal to −4% of the value of the initial transparency (“white bath”) per minute of introduction of colorant with a flow rate of 1 liter per minute, this tangent is reduced to −2% for each minute of introduction of colorant with a flow rate of 0.5 liters per minute. The transparency (X co-ordinate) of the reference point is thus constituted by a series of linear interpolations.

In a variant of these different modes of determining the reference point, at least one non-linear interpolation is applied that takes into account the progress of the physical phenomena utilized, during the period of time D (for example, a coefficient of absorption of colorant by the textile product as a function of the absorption that has already taken place and/or ability of the colorant to be absorbed by the textile product as a function of its concentration in the dye bath) and dyeing parameters (pH and temperature of the dye bath, for example) in order to determine the reference point.

Whatever the mode of determining the reference point 315, the “first strike” rate is thus equal to the ratio of:
the difference between the transparency represented by the reference point and the value of the transparency on the curve at the moment when the introduction of colorant ended, on the one hand, divided by
the difference between the transparency of the clean water (“white bath”) and the transparency (Y co-ordinate) of the reference point.

For example, if the transparency at the end of the initial introduction is equal to the value of the transparency of the reference point, the “first strike” rate is zero.

Thus, at least one interpolation, preferentially linear, is performed for the value of the transparency at the beginning of the injection of colorant to determine a reference transparency value at the end of the injection of colorant in order to determine the “first strike” rate.

If the “first strike” rate is above a predefined value, for example 40%, the user is given an alarm signal, for example by displaying a message on a user interface (not shown), triggering a rotating light and/or alarm bell, in order that the operator can take into account the risk of non-uniform coloration of the textile product and, possibly, stop the dyeing process, empty the bath of dye and the textile product to be dyed and start a new dyeing cycle on another item, or change the operating parameters of the dyeing machine 100, for example the introduction period of time D, for the item being dyed or for the next item, of the same weight of material, which will be dyed with the same colorant.

In a variant, during the step 225, the first strike rate or the value is estimated, throughout the period of time D, and, in the case where this value or this rate is greater, in absolute value, than a predefined value limit, the flow rate of colorant introduced into the dyeing machine is reduced. The control means 149 are thus adapted to control the flow rate of colorant introduced into the dye bath according to evolution of the transparency of the liquid contained in the dye bath.

During a step 230, each spectral range for which the variation in transparency is, during step 220, below a predefined variation rate limit (for example 30%) is eliminated. In a variant, utilized as an alternative to the elimination procedure above, or in the case where it could leave at most one spectral range, a predefined number of spectral ranges (for example one) for which the transparency variations are, during step 220, the smallest, are eliminated.

It is noted that the spectral ranges of interest are often the complementary spectral ranges of the transparency spectral ranges for the colorants used. It is also noted that a number of colorants can react differently with the fibers to be dyed and influence a number of different spectral ranges.

Then, during this step 230, for at least one non-eliminated spectral range, a transparency measurement cycle is carried out, for each spectral range looked at, and the difference between the value measured and a nominal value given by a predefined nominal curve (as a function of time) calculated as a function of the first strike rate or the value and the clean water or white bath transparency, is compared against a predefined value. If the difference between the nominal value and the measured value is below the predefined value, the process proceeds to step 240.

In a variant, step 230 is carried out for each predefined sample thickness then the one with the measurements corresponding to the best approach while avoiding sensor saturation is chosen.

Otherwise, during a step 235, the process actuates:
the closed-loop control means that controls bath acidity or salinity 160,
the closed-loop control means that controls bath temperature 162,
the closed-loop control means that controls the clean water feed 164 and/or
the closed-loop control means that controls the injection of colorant into the bath 166, in order to re-establish the dyeing process's progress so that the transparency value becomes closer to the predefined nominal curve, according to known automatic operations, and the process returns to step 230.

For example, if the exhaustion rate for the bath, which is represented by the transparency captured by the transparency capturing means 140, is below the nominal value given by the nominal curve, the process can, in a known manner, initiate a heating of the bath or a change to its pH value, in order to increase or reduce the speed of exhaustion of the dye bath.

In a variant, during the step 235, at least one alarm, computer (signal representing a dyeing fault), visual (for example a rotating light) or sound (for example an alarm bell), is triggered in order to alert an operator or a computer system so that one of them could on the one hand perform tracking of the event and/or, on the other hand, correct the dyeing machine's operational parameters in order to reduce the consequences of these faults.

During a step 240, the transparency variation, over a predefined period of time (for example one minute), is determined. Then, during a step 245, this variation is compared to a predefined value which is preferentially a function of the value of the reference point 315 and the value for calibration with clean water (“white bath”) and, if the variation is greater than the predefined value, the process returns to step 230. Otherwise, the dyeing process is considered to be finished, and the user is given a signal indicating that the dyeing process is finished, for example by a message on the user interface. During a step 250, the user initiates the rinsing of the textile product by emptying the dye bath and continuously introducing clean water into the bath. In a variant, during step 250, rinsing is initiated automatically.

During a step 255, for each non-eliminated spectral range (see step 230), the difference between the value measured and a nominal value for rinsing, which preferentially depends on the clean water (“white bath”) transparency measured during step 215, the transparency at the start of the rinsing and/or a predefined nominal curve for rinsing, is compared. For example, the nominal value for rinsing is equal to the transparency measured during step 215. If the difference between the nominal value and the measured value is below a predefined value (for example 2%), the process proceeds to step 260.

During step 260, the transparency variation, over a predefined period of time (for example one minute), is determined. Then, during a step 265, this variation is compared to a predefined value which, preferentially, depends on the clean water (“white bath”) transparency measured during step 215, the transparency at the start of the rinsing and/or a predefined nominal curve for rinsing, and, if the variation is greater than the predefined value, the process returns to step 255. Otherwise, the rinsing process is considered to be finished, and the user is given a signal indicating that the dyeing process is finished, for example by a message on the user interface. During a step 270, the user initiates the end of the rinsing of the textile product. In a variant, during step 270, the rinsing is automatically ended by stopping the input of clean water and the movement of the dyed thread or textile item and by emptying the dyeing machine 100.

In a variant, one of steps 255 or 265 is eliminated in such a manner that the rinsing is considered to be finished either when the variation is below the predefined value defined for step 265 (step 255 eliminated), or when the difference defined for step 255 is below the value determined for step 255 (step 265 eliminated).

Steps 250 and following described above are adapted to the case of rinsing by overflow.

In a variant, adapted to the case of rinsing by cycles, after step 245, during a step 275, a first rinse cycle is initiated by emptying the machine of the dye bath and by filling it with clean water.

When it is full, during a step 280, for each non-eliminated spectral range (see step 230), the difference between the value measured and a nominal value for rinsing, which depends on the clean water (“white bath”) transparency measured during step 215, the transparency at the start of the rinsing and/or a predefined nominal curve for rinsing, is compared. For example, the nominal value for rinsing is equal to the transparency measured during step 215. If, at the end of a predefined period of time, the difference between the nominal value and the measured value is below a predefined value, the process proceeds to step 285. Otherwise, step 275 is repeated.

During step 285, the transparency variation, over a predefined period of time (for example the length of time for one cycle), is determined. Then, during a step 290, this variation is compared to a predefined value which, preferentially, depends on the clean water (“white bath”) transparency measured during step 215, the transparency at the start of the rinsing and/or a predefined nominal curve for rinsing, and, if the variation is greater than the predefined value, step 275 is repeated. Otherwise, the rinsing process is considered to be finished, and the user is given a signal indicating that the process is finished, for example by a message on the user interface. During a step 295, the user initiates the end of the rinsing of the textile product. In a variant, during step 295, the rinsing is automatically ended by stopping the cycles of input of clean water and the movement of the dyed thread or textile item and by emptying the dyeing machine.

In a variant, one of steps 280 or 290 is eliminated in such a manner that the rinsing is considered to be finished either when the variation is below the predefined value defined for step 290 (step 280 eliminated), or when the difference defined for step 280 is below the value determined for step 280 (step 290 eliminated).

In a variant, during the rinse step and/or during the dyeing step, the thickness of the sample with which transparency is measured is varied, depending on the evolution of the transparency of the rinse bath or dye bath and, preferentially, a coefficient of correction is applied to the measurements carried out. In this way, a high level of accuracy is maintained for transparency measurements.

It is noted that, in the case where a display is provided, preferentially the curve for evolution of colorant concentration that is displayed is obtained by utilizing the Bert-Lambert law.

FIG. 3 represents a curve of transparency as a function of time and the measurements carried out or calculated with the device shown in FIG. 1 utilizing the logical diagram shown in FIG. 2:
curve 300 represents the value measured for transparency;
tangent 310 represents the line of determination of the reference point 315;
the colorant introduction phase, of length of time D, is represented in 320;
the phase of determining the end of dyeing is represented in 330;
the phase of determining the end of rinsing is represented in 340 and
the additional reference point for clean water (“white bath”) transparency 345.

It is seen that the X co-ordinate for the reference point 315 serves as the zero value for the X co-ordinates and that the values predefined for variation or absolute value of transparency are preferentially determined as a function, on the one hand, of the clean water (“white bath”) transparency and, on the other hand, or the reference point transparency.

For example, the rate of exhaustion looked for at the end of the dyeing phase (used during step 230) corresponds to a transparency equal to the clean water (“white bath”) transparency less 30% of the difference between the transparency of the clean water and the transparency (X co-ordinate) of the reference point 315.

For example, the variation, over a period of five minutes, for the transparency looked for at the end of the dyeing phase (used during step 240) corresponds to 2% of the difference between the transparency of the clean water and the transparency (X co-ordinate) of the reference point 315.

For example, the transparency looked for at the end of the dyeing phase (used during step 280) corresponds to a transparency equal to the clean water (“white bath”) transparency less 2% of the difference between the transparency of the clean water (“white bath”) and the transparency (X co-ordinate) of the reference point 315.

For example, the variation, over a period of five minutes or over a rinse cycle, for the dye bath transparency looked for at the end of the rinse phase (used during step 290) corresponds to 1% of the difference between the transparency of the clean water (“white bath”) and the transparency (X co-ordinate) of the reference point 315.

It is seen that, in the example given in FIG. 3, the determination of the end of dyeing and of the end of rinsing are each carried out by detecting that the variation of the transparency, over a given length of time, is less than a predefined value.

It is noted that the method and the device that are the subject of the present invention can, in a variant, analyze the evolution of colorant concentration in the dye bath, rather than evolution of the transparency of the dye bath. In this case, the determination of the colorant concentration as a function of the transparency uses, preferentially, the Bert-Lambert law, according to known techniques.

The curve represented in FIG. 3 is a curve that corresponds to rinsing by overflow rather than a curve corresponding to rinsing by cycles, in the latter case, the variation in the transparency during the rinsing would have turning points defining a stepped curve, i.e. alternating rapid variations (during a change of cycle) and slow variations (during a cycle) in transparency.

FIGS. 4A to 4G only describe sensors utilizing three spectral ranges. In other embodiments, a larger number of spectral ranges are utilized.

FIG. 4A shows the positioning of the sensor in the circuit 120 when the piston 132 is deployed and the sample thickness, defined by the motor 136 is an average value (for example 0.9 mm.).

FIG. 4B shows the positioning of the sensor outside the circuit 120 when the piston 132 is lowered and the clean water circulates in the pipe 175. It is noted that, preferentially, this clean water circulation is in the opposite direction to the direction of the dye bath circulation, with respect to the transparency capturing means 140, so as to detach the textile fibers that may have been caught on the transparency capturing means 140.

FIG. 4C shows the positioning of the sensor in the circuit 120 when the piston 132 is deployed and the sample thickness, defined by the motor 136, is a minimum value (for example 0.1 mm.).

FIG. 4D shows the positioning of the sensor in the circuit 120 when the piston 132 is deployed and the sample thickness, defined by the motor 136, is a maximum value (for example 7.2 mm.).

It is noted that, preferentially, the thicknesses define a noticeably geometric series, which means that the ratio of two successive thicknesses is noticeably constant (here 9, then 8).

FIG. 4E shows the light source 142, opposite three bundles of optical fibers 144A, 144B and 144C placed a different distances from the light source, for example 0.2 mm., 1.2 mm. and 7 mm and separated optically by opaque partitions (not shown). The other extremity of each bundle of optical fibers is facing:
a phototransistor 405 that captures blue wavelengths, for example
a phototransistor 410 that captures red wavelengths, for example and
a phototransistor 415 that captures green wavelengths, for example.

Preferentially, the transistors 405 (410 and 415 respectively) are placed in parallel behind the same interference filter, across from the bundle of optical fibers corresponding to them and separated optically in order to avoid cross influence.

The power supply circuits for the phototransistors are controlled by multiplexers (not shown) according to the intensity of the signals received by these phototransistors. The phototransistor outputs are linked to the digitizer by multiplexers 425 (connections not shown). The choice of path A, B or C is made in order to optimize the dynamics of the signals received. Possibly, this choice is a function of the identification of the colorant or colorants to be used and a quantity of colorant to be injected into the dye bath during step 200.

In a variant, all the bundles of optical fibers corresponding to the same thickness lead to the same image sensor, for example a charge-coupled device (CCD) or C-MOS sensor equipped with colored filters.

FIG. 4F shows a bundle of optical fibers 450 placed, in the pipe 124, opposite a prism 452 forming two successive mirrors placed at 45° to the axis of the illuminating bundle of optical fibers 450 and to the axis of a bundle of optical fibers 458 whose output is facing:
a phototransistor that captures blue wavelengths 460,
a phototransistor that captures red wavelengths 461 and
a phototransistor that captures green wavelengths 462.

The light rays output from the bundle of optical fibers 450 are directed, by the prism 452, to the input of the bundle of optical fibers 458.

The outputs of the phototransistors are linked to the digitizer by a multiplexer 465.

FIGS. 4E and 4F represent the capture of transparency in three spectral ranges and by three phototransistors for each sample thickness. However, the invention is independent of the number of spectral ranges used, in the visible field or not. For example, four spectral ranges in the visible field, defined by four interference filters, can be used.

FIG. 4G shows, in the analysis chamber 130, an image sensor 500, for example a C-MOS image sensor (which possesses significant dynamics, with respect to the charge-coupled devices), facing the light source 510, for example an output from a bundle of optical fibers or a light-emitting diode in such a way that the light source is located, according to the point (or pixel) of the image sensor's surface, at different distances and/or different solid angles in proportions ranging at least from one to ten. For example, the light source is positioned at 0.2 mm. from a corner of the image sensor in such a way that the opposite corner is positioned several millimeters from this light source. Image processing is then performed to select the signals output from the image sensor points that exploit the image sensor's dynamics and that are not influenced by image points suffering from too much illumination, in order to determine the dye bath transparency.

It is noted that an image sensor comprising colored filters or a light source able to successively output light rays in different spectral ranges can be used, as explained, with respect to FIG. 6B.

In the case of a C-MOS sensor or any other type of sensor in which electrical charges are accumulated in pixels of the image sensor according to the illumination of these pixels, and in which these charges are extracted by point-by-point addressing, preferentially, the charges of the pixels closest to the light source are emptied more often that the charges of the pixels of the image sensor that are farthest away from the light source. The frequency for emptying the charges is, for example, in each pixel of the image sensor, proportional to the illumination of these pixels. In this manner, the pixels with the most illumination do not risk being damaged by the excess electrical charges and these do not risk interfering with the transparency measurement.

Possibly, measurements corresponding to pixels of the image sensor that exploit the same part of the dynamics of the sensor are combined in order to improve the signal/noise ratio for the measurement.

As can be seen with respect to FIGS. 4A to 4G, the control means 149 comprise closed-loop control means 136 for controlling the sensitivity of the sensor 140, according to the opacity of the liquid contained in the dye bath.

In the case represented in the figures:
the control means 149 comprise closed-loop control means 136 that controls the optical path taken by a light ray generated by the sensor in the liquid contained in the dye bath, according to the opacity of the liquid contained in the dye bath;
an adjusting means (here the displacement means 136), that adjusts the sample thickness of the dye bath water whose transparency is captured by the transparency sensor, and that is controlled by the control means 149 in such a way that the sample thickness is increased according to the transparency of the bath;
the adjusting means for adjusting the thickness is adapted to displace, with relation to each other, a light source and at least one optical fiber.

In a variant, shown in FIG. 4G, the control means 149 comprise:
closed-loop control means for controlling the capture period of time for the sensor according to the opacity of the liquid contained in the dye bath and/or
closed-loop control means for controlling an amplifying means that amplifies the signal/noise ratio of the signal output by the sensor, according to the opacity of the liquid contained in the dye bath.

In a variant of the embodiments described above, at least two light sources are utilized that are adapted to output different quantities of light with respect to the sensor and a switching means that controls the lighting up of just one of said light sources at a time, according to the transparency looked for or the measurement of the dye bath or the rinsing.

FIG. 5 shows a device 500 utilizing at least one aspect of the present invention, associated to a dyeing machine 505, filled with a bath 510, and which comprises:
a dye bath circulation circuit 520, comprising a pump 522, a pipe 524 removing bath water in the bath 510 and re-injecting it into the bath 510,
a clean water circuit 536 parallel to the dye bath circulation circuit 520;
a mobile analysis chamber 530 in a piston 532 moved by a motor 534 in a cylinder 533, and comprising a transparency capturing means 540 comprising a light source 542 (see FIGS. 6A and 6B) and at least one optical fiber 544 whose output is opposite to a sensor 546 linked to a digitizer 548,
control means 549 comprising:
   . an analyzing means for analyzing signals 550 receiving the digitized signals output from the digitizer 548 and supplying an analysis result,
   . a closed-loop control means 560 that controls the acidity and/or salinity of the bath,
   . a closed-loop control means 562 that controls the temperature of the bath,
   . a closed-loop control means 564 that controls the clean water feed,
   . a closed-loop control means 566 that controls the injection of colorant into the bath,
   . a multiplexer 568 adapted to control the output, by the light source 542, of light rays in successively different emission spectra and to transmit a demultiplexing signal to the analyzing means for analyzing signals 550 and
   . a control means 570 for controlling the motor 534 of the piston 532.

The dyeing machine 505 and the composition of the dye bath 510 are of known types in the textile industry. The circulation circuit of the dye bath 520 already exists in a large number of dyeing machines. The pump 522 and the pipe 524 are of known type and are constituted by materials that do not risk polluting the dye bath or distorting its analysis. Preferentially, the pump 522 has a constant flow rate, possibly adjustable.

The mobile analysis chamber 530 is set in movement by the motor 534 in at least three positions. In a first position, the highest, the mobile analysis chamber 530 has a fluid link to the dye bath circulation circuit 520 and receives a dye bath sample. In a second, middle, position, the mobile analysis chamber 530 does not have a fluid link with either the dye bath circulation circuit 520, or the clean water circuit 536 in order that the sample can rest, that the bubbles it contains can escape away from the optical field of the sensor 546 and that the transparency capture is carried out, in each optical spectral band of interest. In a third position, the lowest, the mobile analysis chamber 530 has a fluid link with the clean water circuit 536 and is purged of the sample.

Thanks to this piston mechanism, it is no longer necessary to have a pipe specific to the dyeing machine control device and the complexity and costs of manufacturing, installing and maintaining this device are substantially reduced.

In the analysis chamber 530, the distance between the input of the bundle of optical fibers 544 and the light source is constant, preferentially, in the range of values going from 0.2 mm. to 7 mm.

Under the control of the multiplexer 568, the light source 542 is adapted to successively output light rays in different spectral bands. The light source 542 comprises, for example, a plurality of light-emitting diodes where the total of the output light spectra covers, preferentially, at least the visible spectrum (see FIG. 6A). In a variant, the light source 542 comprises a light-emitting diode whose output light spectrum varies according to an electric characteristic that is applied to it (see FIG. 6B). For example, the voltage applied to the light source 542 changes its output light spectrum.

In a variant, the light source 542 is an incandescent bulb or a halogen light to which a variable voltage is applied so that the output spectrum varies during an analysis cycle. The digitizer 548, of known type, digitizes the signal output from the sensor 546.

The analyzing means for analyzing signals 550, which receives the signals coming from the digitizer 548, utilizes the logical diagram shown in FIG. 7 to calibrate the transparency capturing means then, in order to provide, from the demultiplexing signal sent by the multiplexer 568 and signals coming from the digitizer 548, an analysis result in the form of at least one transparency value and a comparison of this value against predefined threshold values according to the composition of the dye bath. The analyzing means for analyzing signals 550 is, for example, constituted of a computer programmed to implement the steps shown in FIG. 7. It comprises a user interface (not shown) comprising a display screen, a keyboard and, possibly, a pointing device, for example a mouse.

The closed-loop control means for controlling bath acidity and/or salinity 560, the closed-loop control means for controlling bath temperature 562, the closed-loop control means for controlling the clean water feed 564 and the closed-loop control means for controlling the injection of colorant into the bath 566 respectively control, depending on the results provided by the analyzing means for analyzing signals, the operation of at least one valve for injecting chemical components into the bath, the operation of a heat source, for example constituted of a heat exchanger or a steam pipe, a clean water feed valve, a valve for injecting colorant into the bath. It is noted that the term “valve” does not prejudge the state, liquid, solid or gaseous, of the colorant or colorants and/or the other chemical components, for example alkalines, that may be injected into the dye bath.

It is noted that the control of these different actuators, carried out in the description, under the control of the analyzing means 550, may be performed by a programmer external to the device, programmer generally already present on dyeing machines. This other programmer is thus programmed to control the actuators according to the signals coming from the analyzing means 550.

FIG. 6A shows the mobile analysis chamber 530 in the piston 532 moved by the motor 534. In FIG. 6A, the light source 542A comprises seven light-emitting diodes 605 in formation, where a central diode is in contact with six diodes forming a outer ring with each being an equal distance from the central diode. The total of the output light spectra for the light-emitting diodes 605 covers the visible light spectrum. For example, each diode 605 has a spectrum width of approximately 50 nanometers.

All the diodes 605 noticeably cover the same solid angle enclosing the input of the optical fiber 544, the axes of the light-emitting diodes all being oriented towards the center of the input surface of the optical fiber 544.

FIG. 6B shows the mobile analysis chamber 530 in the piston 532 moved by the motor 534. In FIG. 6B, the light source 542B comprises a single light-emitting diode 655, placed in front of the input of the optical fiber 544, to which a synchronized sawtooth voltage signal is applied by the multiplexer 568. The sum of the successive output light spectra of the light-emitting diode 655 covers the visible light spectrum.

FIG. 7 shows a series of steps carried out by the embodiment of the device shown in FIGS. 5, 6A and 6B.

During a step 700 of the industrial process selection, a user selects a dye process by indicating the material weight to be dyed and the colorant or colorants to be used and the quantity of colorant to be injected into the dye bath. In a variant, this data is not utilized, as explained with respect to FIG. 2. During a step 702, the displacement and positioning of the piston 532 are requested in order to position the transparency capturing means 540 in the dye bath circulation circuit 520.

During a step 704, the introduction of clean water into the dye beck is initiated. In a variant steps 702 and 704 are replaced by step 706, during which the displacement and positioning of the piston 532 are requested in order to position the transparency capturing means 540 in the clean water circuit 536, and step 718 indicated later.

During a step 710, clean water (or the “white bath”) flows through the analysis chamber 530 and, during the seven successive steps 711 to 717, the multiplexer 568 successively requests the output of light by the light source 542 in seven different spectral ranges or output spectra covering preferentially the whole of the visible spectrum. For each output spectrum, in a predefined period of time following the start of its output, the analyzing means memorizes the digital value output from the digitizer during the passage of clean water. The start and duration of this interval can vary according to the output spectrum for example to compensate for the differences in candlepower output and the sensitivity of the sensor to the different spectral ranges.

Preferentially, a number of digital values are obtained and it is their average (after possibly excluding values too far from the average value) that is memorized for each light spectrum.

During a step of variant 718, the displacement and positioning of the piston 532 are requested in order to position the transparency capturing means 540 in the dye bath circulation circuit 520.

Then, during a step 720, the introduction, into the dye bath, of colorants and, possibly, of chemical components intended to activate or complete the dyeing of the textile product in the dye bath, are initiated and the heating of the dye bath is initiated. During step 720, of a duration D, a number of cycles are carried out of sampling, with the piston in the high position, leaving the sample to rest, in the middle position, measuring transparency for different output spectra of the light source, with the piston in the middle position, and purging the transparency capturing means, with the piston in the low position.

For each cycle, the analyzing means memorizes the digital value output from the digitizer, for each output light spectrum of the light source, controlled by the multiplexer 568, respecting the same predefined time intervals as those utilized during steps 711 to 717, each time interval, which corresponds to an output spectrum, being defined:
by the length of time that separates the start of this time interval, on the one hand, from the output spectrum change request sent by the multiplexer 568, on the other hand, and
by the length of the time interval.

When the initial introduction of colorants and chemical components is finished, during a step 725, the analyzing means determines:
the reference point of the curve of future values and
the “first strike” rate.

The reference point of the curve is the point of the tangent on the transparency curve as a function of time (see FIG. 3) at the time of the end of the initial introduction of colorants and chemical components.

The “first strike” rate is equal to the ratio of the difference between the transparency represented by the reference point and the transparency value on the curve at the time of the end of the initial introduction, on the one hand, over the difference between the clean water (“white bath”) transparency and the transparency represented by the reference point. Thus, if the transparency at the end of the initial introduction is equal to the value of the transparency represented by the reference point, the “first strike” rate is zero.

Therefore, a linear interpolation of the value of the transparency at the start of the injection of colorant is performed to determine a reference transparency value at the end of the injection of colorant in order to determine the “first strike” rate.

If the “first strike” rate is greater than a predefined value, for example 40%, the user is given an alarm signal, for example by displaying a message on the user interface so that the user can take into account the risk of non-uniform coloration and, possibly, stop the dyeing process, empty the bath of dye and the textile product to be dyed and start a new dyeing cycle on another item.

Depending on the variants, the results are combined mathematically to determine an overall result or the highest value is taken.

During a step 730, a transparency measurement cycle is carried out, for each output light spectrum, respecting the different piston positions and the different measurement time intervals and the difference between the measured value and a nominal value given by a predefined nominal curve is compared against a predefined value. If the difference between the nominal value and the measured value is less than the predefined value, the process proceeds to step 740. Otherwise, during a step 735:
the closed-loop control means that controls bath acidity and/or salinity 560,
the closed-loop control means that controls bath temperature 562,
the closed-loop control means that controls the clean water feed 564,
the closed-loop control means that controls the injection of colorant into the bath 566, and/or
the closed-loop control means that controls the injection of chemical components into the bath 568 are controlled in order to re-establish the dyeing process's progress, according to known automatic operations, and the process returns to step 730.

In a variant, the nominal curve is not used, but the adjustment is performed according to the transparencies measured where the derivative of the transparencies tends to zero. A nominal program is therefore used.

During a step 740, the transparency variation, over a predefined period of time (for example fifteen seconds), is determined. Then, during a step 745, this variation is compared to a predefined value, which can be a function of the reference point value and the clean water (“white bath”) calibration value and, if the variation is greater than the predefined value, the process returns to step 730. Otherwise, the dyeing process is considered to be finished and the user is given a signal indicating that the process is finished, for example by a message on the user interface. During a step 750, the user initiates the rinsing of the textile product by emptying the bath of dye and introducing clean water into the bath. In a variant, during step 750, rinsing is initiated automatically.

During a step 755, a cycle is carried out of measuring transparency for the different output spectra and comparing the difference between the measured value and a nominal value for rinsing, which depends on the clean water (“white bath”) transparency measured during steps 711 to 717, the transparency at the start of the rinsing and/or a predefined nominal curve for rinsing. For example, the nominal value for rinsing is equal to the transparency measured during steps 711 to 717. If the difference between the nominal value and the measured value is less than a predefined value, the process proceeds to step 760.

During step 760, the transparency variation, over a predefined period of time (for example one minute), is determined. Then, during a step 765, this variation is compared to a predefined value, which depends on the clean water (“white bath”) transparency measured during steps 711 to 717, the transparency at the start of the rinsing and/or a predefined nominal curve for rinsing and, if the variation is greater than the predefined value, the process returns to step 755. Otherwise, the rinsing process is considered to be finished and the user is given a signal indicating that the process is finished, for example by a message on the user interface. During a step 770, the user initiates the end of the rinsing of the textile product. In a variant, during step 770, the rinsing is automatically ended.

Steps 750 to 770 described above are adapted to the case of rinsing by overflow.

In a variant, adapted to the case of rinsing by cycles, after step 745, during a step 775, a first rinse cycle is initiated by emptying the machine of the dye bath and by filling it with clean water.

When it is full, during a step 780, a measurement cycle is carried out for each spectral range looked at and, for each non-eliminated spectral range (see step 230), the comparison between the value measured and a nominal value for rinsing, which depends on the clean water (“white bath”) transparency measured during step 715, the transparency at the start of the rinsing and/or a predefined nominal curve for rinsing, is made. For example, the nominal value for rinsing is equal to the transparency measured during step 715. If, at the end of a predefined period of time, the difference between the nominal value and the measured value is below a predefined value, the process proceeds to step 785. Otherwise, step 775 is repeated.

During step 785, the transparency variation, over a predefined period of time (for example the length of time for one cycle), is determined. Then, during a step 790, this variation is compared to a predefined value which, preferentially, depends on the clean water (“white bath”) transparency measured during step 715, the transparency at the start of the rinsing and/or a predefined nominal curve for rinsing, and, if the variation is greater than the predefined value, step 775 is repeated. Otherwise, the rinsing process is considered to be finished, and the user is given a signal indicating that the process is finished, for example by a message on the user interface. During a step 795, the user initiates the end of the rinsing of the textile product. In a variant, during step 795, the rinsing is automatically ended by stopping the cycles of input of clean water and the movement of the dyed thread or textile item and by emptying the dyeing machine.

In a variant, one of steps 780 or 790 is eliminated in such a manner that the rinsing is considered to be finished either when the variation is below the predefined value defined for step 790 (step 780 eliminated), or when the difference defined for step 780 is below the value determined for step 780 (step 790 eliminated).

During steps 711 to 717 and 730, the piston is in a middle position or the sample is resting.

In this way, the piston is adapted to take at least three positions, in which, respectively:
a water passage is open opposite to the circuit of clean water under pressure,
the water passage is opposite to the liquid circulation circuit comprising the dye bath and
the water passage is blocked off and opposite to the sensor.

Thus, in the embodiment shown in FIGS. 5 to 7, the measurement of the dye bath's transparency is no longer hindered by the presence of bubbles or foam in the dye bath, thanks to the utilization of a separating means for separating said dye bath sample and for resting said sample, the sample transparency sensor being adapted to provide a signal representing the transparency of said sample for at least one spectral range, when this sample is separated from the dye bath.

In effect, once the sample has been separated from the dye bath and left to rest, the bubbles possibly present in the sample are progressively released from the liquid and the sensor can measure the actual transparency of the liquid.

Preferentially, the device comprises an anti-foam filter positioned between the position of the sample at the moment it is taken and the position of the sample separated from the dye bath.

As has been seen, the dye bath monitoring device described with respect to FIGS. 5 to 7 comprises:
a transparency measurement chamber for liquid coming from the dye bath comprising a light source adapted to successively output light in a plurality of different spectral bands,
a single optoelectronic sensor adapted to receive the light rays coming from the light source after their passage through the measurement chamber and to output a signal representing the quantity of light received by said sensor and
a demodulator synchronized with the light source to successively process the signals coming from the sensor to supply results corresponding to the different spectral bands successively output by the light source.

Thanks to these provisions, a single sensor is necessary to process the different spectral bands used for measuring the bath's transparency and to monitor the dye bath's exhaustion or the rinse operation.

Any combination of the different embodiments of the present invention described above constitutes a variant of each of these embodiments. For example, an optical fiber may be replaced by a bundle of optical fibers, the displacement means described in FIGS. 1 to 4 may be eliminated or, on the contrary, added in the embodiment described in FIGS. 5 and 7.

1-38. (canceled)

39. A monitoring device for a dye bath adapted to be combined with a dyeing machine comprising at least one liquid circulation circuit containing a portion of said dye bath, that comprises:
a transparency sensor for the liquid contained in said bath adapted to supply a signal representing the transparency of said portion of the dye bath for at least one spectral range and
positioning means for positioning the transparency sensor in a said liquid circulation circuit.

40. The monitoring device of claim 39, wherein the positioning means comprises a sensor support adaptable to said liquid circulation circuit.

41. The monitoring device of claim 39, wherein the positioning means comprises a displacement means for said sensor adapted to move the sensor into or outside the portion of the dye bath contained in the liquid circulation circuit.

42. The monitoring device of claim 41, wherein said displacement means comprises a piston placed transversely with respect to said liquid circulation circuit.

43. The monitoring device of claim 39, that further comprises control means that control the end of a dyeing period of the dyeing machine or the end of a rinse period of the dyeing machine according to the evolution of the bath's transparency.

44. The monitoring device according to claim 43, wherein the control means are adapted to determine the end of the dyeing period or the end of the rinse period when the derivative for the transparency value is below a predefined value.

45. The monitoring device of claim 39, that further comprises closed-loop control means that control the transparency sensor's sensitivity according to the signal representing the transparency of the said portion of the dye bath.

46. The monitoring device of claim 39, that further comprises closed-loop control means that control the optic path taken by a light ray generated by the transparency sensor in said portion of the dye bath according to the signal representing the transparency of said portion of the dye bath.

47. The monitoring of claim 46, that further comprises an adjusting means for adjusting the thickness of a sample of dye bath whose transparency is captured by the transparency sensor, wherein the closed-loop control means are adapted to control the adjusting means for adjusting said thickness in such a manner that the sample thickness is increased according to the transparency of the bath represented by the signal provided by the transparency sensor.

48. The monitoring device of claim 47, wherein the adjusting means that adjusts thickness is adapted to displace, with relation to each other, a light source and at least one optical fiber.

49. The monitoring device of claim 39, that further comprises closed-loop control means for controlling a capture period of time for the transparency sensor according to the transparency of said portion of the dye bath.

50. The monitoring device of claim 39, that further comprises closed-loop control means for controlling amplification means that amplifies the signal/noise ratio of said signal representing the transparency of said portion of dye bath, according to said transparency.

51. The monitoring device of claim 39, that further comprises control means that control the acidity and/or the salinity of the dye bath according to evolution of the transparency of said portion of dye bath.

52. The monitoring device of claim 39, that further comprises control means that control the temperature of the bath according to evolution of the transparency of said portion of the dye bath.

53. The monitoring device of claim 39, that further comprises control means that control a quantity of clean water introduced into the dye bath according to evolution of the transparency of said portion of the dye bath.

54. The monitoring device of claim 39, that further comprises control means that control the quantity of colorant introduced into the dye bath according to evolution of the transparency of said portion of the dye bath.

55. The monitoring device of claim 39, that further comprises control means that control the quantity of chemical components introduced into the dye bath according to evolution of the transparency of said portion of the dye bath.

56. The monitoring device of claim 39, that further comprises a taking means for taking a sample of the dye bath and a separating means for separating said sample from the dye bath and leaving said sample to rest for a period, the transparency sensor being adapted to sense the transparency of the sample separated from the dye bath.

57. The monitoring device of claim 39, wherein the transparency sensor comprises a transparency measurement chamber for liquid coming from the dye bath comprising a light source adapted to successively output light in a plurality of different spectral bands, a single optoelectronic sensor adapted to receive the light rays coming from the light source after their passage through the measurement chamber and to output a signal representing the quantity of light received by said sensor and a demodulator synchronized with the light source to successively process the signals coming from the sensor to supply results corresponding to the different spectral bands successively output by the light source.

58. A dye bath monitoring method intended to be utilized in a dye bath monitoring device combined with a dyeing machine comprising at least one liquid circulation circuit comprising the dye bath, characterized in that it comprises:
a step of positioning a transparency sensor in a said liquid circulation circuit comprising the dye bath and
a step of capturing the transparency of the liquid contained in said bath, during which a signal representing the transparency of said bath is provided for at least one color.
